(19) United States
(12) Patent Application Publication
(10) Pub. No.: US 2014/0032466 A1
(43) Pub. Date: Jan. 30, 2014

(54) Computer system of artificial intelligence of a cyborg or an android, wherein a received signal-reaction of the computer system of artificial intelligence of the cyborg or the android, an association of the computer system of artificial intelligence of the cyborg or the android, a thought of the computer system of artificial intelligence of the cyborg or the android are substantiated, and a working method of this computer system of artificial intelligence of a cyborg or an android

(71) Applicant: Boris Kaplan, Munich (DE)

(72) Inventor: Boris Kaplan, Munich (DE)

(21) Appl. No.: 13/507,798

(22) Filed: Jul. 30, 2012

(51) Int. Cl. G06N 5/00

(52) U.S. Cl. 706/45

(57) ABSTRACT

A computer system of Artificial ntelligence of a cyborg or an android, wherein a received signal-reaction of the computer system of Artificial Intelligence of the cyborg or the android, an association of the computer system of Artificial Intelligence of the cyborg or the android, a thought of the computer system of Artificial Intelligence of the cyborg or the android are substantiated, and a working method of this computer system. The computer system is based on one natural language. The computer system includes at least five senses equipped with sense organs, wherein the senses are a sense of sight, a sense of hearing, a sense of smell, a sense of taste, a sense of touch. The sensors network of the computer system summarizes all reactions of all sense organs of all the senses. For another natural language, the computer system uses the references to the thoughts of this computer system.

### TECHNICAL FIELD

The present invention relates to a computer system of Artificial Intelligence of a cyborg or an android, wherein a received signal-reaction of the computer system of Artificial Intelligence of the cyborg or the android, an association of the computer system of Artificial Intelligence of the cyborg or the android, a thought of the computer system of Artificial Intelligence of the cyborg or the android are substantiated, and to a working method of this computer system of Artificial Intelligence of a cyborg or an android. The computer system of Artificial Intelligence is based on one natural language.

### BACKGROUND OF THE INVENTION

Systems of artificial intelligence for the classification of events, objects or situations, for example, which provide the classification of seismic events, are known from the European patent (FR 9908472, DE 60005350). The systems are based on the fuzzy expert system (FES). That invention is not planned as a computer system of Artificial Intelligence of a cyborg or an android as well as it is not based on one natural language.

From the European patent (JP 32376590, DE 69132026), a software work tool, which is used in software work for an information processing apparatus, is known. It manages software on the field of the artificial intelligence dynamically. The point from that invention is not a computer system of Artificial Intelligence of a cyborg or an android. It is about the tool, which manages the software to run-time intelligently and dynamically.

A system for adding attributes to an object at run-time in an object oriented computer environment is known from the European patent (US 96112432, DE 69616449). In that system, the procedure for assigning a property to an object by a computer system is implemented. The computer system contains a definition of a class, which specifies one or several class properties from an object, and the computer system adds attributes to an object to compile time at run-time. The point from that invention is not a computer system of Artificial Intelligence of a cyborg or an android. By object modeling, it is about the use of a computer language and a compiler.

A system and method using natural language understanding for speech controlled application are known by the European patent (US 93293897, DE 69814114). That invention relates, in general to computerized natural voice systems, in particular to a computer system and method for providing speech understanding abilities to an interactive voice response system or a computer system and method to interpreting of utterances by a speech recognition application, provided with boundary conditions. The computer system is based on a fix, predetermined, annotated ASR corpus file, which contains an enumeration of all expected valid utterances. That invention is not planned as a computer system of Artificial Intelligence of a cyborg or an android.

In the European patent (EP 93918750, DE 69303013), the use of a language with a similar representation for programs and data by the distributed data processing is patented. That invention is based on a computer language.

By the European patent (KR 2003000254, DE 10361726), a robot toy with artificial intelligence and control method for it are patented. Several patent claims specific for a robot are disclosed by the patent. The Artificial Intelligence of the robot toy is planned for its mechanical control.

From the American patent (U.S. Pat. No. 5,963,663 A), a land mark recognition method for mobile robot navigation is known. Signs (the land marks) are identified as objects in that invention. In the invention, with help of an object recognition apparatus, which works after the principle of the pattern recognition of the neuronal net, a pattern of a signal is differentiated from another pattern. The input signal is decomposed on the red value, the green value and the blue value for the pattern recognition. The invention makes it possible that a robot can execute the different technical tasks, for example, to transport objects in plants. The main point of that invention is not a computer system of Artificial Intelligence of a cyborg or an android.

The article “A survey of socially interactive robots”, T. Fong, I. Nourbakhsh, K. Dautenhahn, Robotics and Autonomous Systems 42 (2003), pp. 143-166, is relevant to the state of the related art. That article is focused on social peer-to-peer human-robot interaction (HRI). The important topics of the article are:

1. design of a robot for human-robot interaction, for example, “For this reason, more and more robots are being equipped with faces, speech recognition, lip-reading skills, and other features and capacities that make robot-human interaction “human-like” or at least “creature-like”” or the material, for example, “The form and structure of a robot is important because it helps establish social expectations”;

2. emotions of humans during human-robot interaction, for example:

2.1. “The primary parameters that govern the emotional content of speech are loudness, pitch (level, variation, range), and prosody”;

3. human-robot dialogue during human-robot interaction, for example:

3.1. “. . . a robot dog learns simple words describing the presence of objects (ball, red, etc.), its behavior (walk, sit) and its body parts (leg, head)”;

3.2. the language recognition can be used by navigation, obstacle avoidance, etc. or by a museum tour;

3.3. “To what extent human-robot interfaces should be based on natural language remains clearly an open issue”;

4. creating robots for human-robot interaction which can imitate humans:

4.1. “In order for imitation to be useful, the robot must decide not only when to start/stop imitating, but also when it is appropriate . . . ”;

5. difference between conventional and socially interactive robots, the artificial social agents:

5.1. “A key difference between conventional and socially interactive robots is that the way in which a human perceives a robot establishes expectations that guide his interaction with it”.

The article “Toward Building a Social Robot with an Emotion-Based Internal Control and External Communication to Enhance Human-Robot Interaction”, Andreas Hendro Marpaung, B.S. University of Central Florida, 2002, is relevant to the state of the related art. In the article of Andreas H. Marpaung, the following topics are described, for example:

1. a natural language: “The avatar is present on the laptop/Cherry's user interface and has voice ability so that she can speak to the user in natural language. She explains a variety of facts, from who she is and what her mission is, namely the UCF computer science tour guide, to which professor works in what office, to what that particular professor is researching.”

2. emotions: “Lola is also capable of displaying her current emotion states that follows the same emotion transitions as in Cherry's but are triggered differently. Unlike Cherry, whose emotions are triggered by the open or closed door and the recognized or unrecognized person, Lola's emotions are triggered because of the repetitive tasks that need to be performed following these rules:

If PERFORMITR==0 then EMOTION-LIKE-STATE=“Happy”

Elseif PERFORMITR==2 then EMOTION-LIKE-STATE=“Frustrated”

Elseif PERFORMITR==4 then EMOTION-LIKE-STATE=“Discouraged”

Elseif PERFORMITR==6 then EMOTION-LIKE-STATE=“Angry”

where PERFORMITR is the frequency of the same task performed sequentially represented by numerical values between 0 and 6, and EMOTION-LIKE-STATE is her emotion state (Happy, Frustrated, Discouraged, AngryεEMOTION-LIKE-STATE). For example, she feels frustrated if she needs to introduce herself more than twice.”

3. behavior: “This behavior can be further divided into three broad categories: reflexive behaviors, “hardwired” responses to the stimuli so the response time can be shortened; reactive behaviors, learned behaviors that then can be produced without conscious thought; and conscious thought, deliberate behaviors. Out of these three types, the reflexive behavior was chosen for this project because the sensory motor level responds to the stimuli.

After the perceptual system filters the stimuli, the system sends them to the ESG. They are then forwarded to the BSG. Currently, the BSG is built as a simple mechanism that helps smoothen the navigation by centering the robot in the middle of the aisle and avoiding any simple obstacles. Through these outputs from the perceptual systems, the robot can execute different behaviors depending on the input source. Each behavior state is described below:

INIT: Reset the emotion and the progress bars to the default setting—happy—and the initial position to room 204.

STAY_CENTER: Center herself between the aisles to avoid the walls.

AVOID_LEFT_WALL: Move to the right to avoid the left wall. This behavior is triggered should course correction calculated by sonar and/or vision be needed.

AVOID_RIGHT_WALL: Move to the left to avoid the right wall. This behavior is triggered should the course correction be needed . . . ”

In this article, a received signal-reaction of a cyborg or an android, a corresponding association of a cyborg or an android, and a corresponding thought of a cyborg or an android are not physically substantiated. The received signal-reaction of a cyborg or an android is not the same as a signal or some signals of sensors of a sense. An association of a cyborg or an android is not taken into consideration in the article. The thoughts of a cyborg or an android are not described in detail in the article. A received signal-reaction of a cyborg or an android, a corresponding association of a cyborg or an android, and a corresponding thought of a cyborg or an android are also not a subject matter of the article.

The article “Towards Development of Multilingual Spoken Dialogue Systems”, Interactive Systems Laboratories, Universitat Karlsruhe, Germany, of Hartwig Holzapfel is relevant to the state of the related art. The article is about:

1. “We describe our experiences with designing multilingual dialogue systems and present methods for multilingual grammar specification, as well as development and maintenance methods for multilingual grammars used for language understanding, and multilingual generation templates.”

2. “We use the option of Ibis to decode with context free grammars (CFG) instead of statistical n-gram language models (LM).”;

3. “4.1. Multilingual Grammars with Grammar Inheritance” “Vectorized context free grammars are similar to (semantic) context free grammars, in that they exist of a set of nonterminal symbols, a set of terminal symbols, a set of rules and a set of start symbols, and semantic annotation of right hand side elements of a rule. In addition, vectorized context free grammars allow multiple inheritance of nodes and definition of vectorized nonterminal symbols. A vectorized nonterminal consists of a vector <e1, e2, . . . , en> where ei is an element of a partially ordered set Vi.”;

4. “The following code line shows an invocation of a template function informing the user that a given object is available.

#Available {$objs.first.[OBJ|NAME]}

The String “$objs.first.[OBJ|NAME]” calls a dialogue variable by accessing discourse information with the given typed feature structure path “[OBJ|NAME]”.”;

5. “Using grammar interfaces and rule inheritance, the definition of a rule containing the name of a lecture looks as follows. A rule interface (frame definition)

iframe<act_askPlace,VP,_>=

<obj_Place,N,_,_>{PLACE obj_Place}

requires that the rule<obj Place,N,, > is defined in all implementing language specific grammars. Then two rules, one for English (with language tag EN) <obj Place,N,,EN > and one for Spanish (with language tag ES) <obj Place,N,,ES > are specified. The right hand side of both rules contains a database import instruction. The import statement specifies the database location, table, field, and semantic value.

<obj_Place,N,_,ES>=import

$db Lecture PlaceES {PLACE import}”.

The article “Data Models in Database Management”, E. F. Codd, IBM Research Laboratory, San Jose, Calif. 95193, is relevant to the state of the related art. The article is about:

“1 WHAT IS A DATA MODEL?

It is a combination of three components:

1) a collection of data structure types (the building blocks of any database that conforms to the model);

2) a collection of operators or inferencing rules, which can be applied to any valid instances of the data types listed in (1), to retrieve or derive data from any parts of those structures in any combinations desired;

3) a collection of general integrity rules, which implicitly or explicitly define the set of consistent database states or changes of state or both—these rules may sometimes be expressed as insert-update-delete rules.”

“2 PURPOSES OF A DATA MODEL

A data model may be used in any of the following ways:

1) as a tool for specifying the kinds of data and data organization that are permissible in a specific database;

2) as a basis for developing a general design methodology for databases;

3) as a basis for coping with evolution of databases so as to have minimal logical impact on existing application programs and terminal activities;

4) as a basis for the development of families of very high level languages for query and data manipulation . . . ”;

Primary Keys:

“Likewise, primary keys (whether they have system-controlled surrogates or user-controlled identifiers as values) are at a higher level than pointers. A particular occurrence of a value V of a primary key makes reference to all other occurrences of V in the database that are drawn from the domain of that primary key. Surrogates have the property that they are distinct if they represent distinct objects in the real world. They are at a higher level than DBTG database keys, which are record identifiers that are distinct for distinct records. Note that there may be two or more records describing a single real world object, in which case there are two or more database keys corresponding to one surrogate. Moreover, within one record there may be two or more surrogates and only one database key.”

A robot control system and method for introducing robot control software is known from American patent (U.S. Pat. No. 6,760,648). That invention is about:

1. “The present invention has been developed in view of the above objects, and in one aspect relates to a robot control system which controls a robot including a combination of a plurality of hardware elements using a hardware dependent software program and a hardware independent software program. The robot control system includes hardware independent software program providing means for providing the hardware independent software program, hardware dependent software program providing means for providing at least one hardware dependent software program, hardware configuration information acquisition means for acquiring hardware configuration information of the robot, hardware dependent software program selection means for selecting a hardware dependent software program, compatible with the hardware configuration information acquired by the hardware configuration information acquisition means, in the hardware dependent software providing means, and software introduction means for introducing, into the system, the hardware independent software program provided by the hardware independent software program providing means, and the hardware dependent software program selected by the hardware dependent software selection means.”

2. “The present invention in a second aspect relates to a robot control software program introducing method for introducing a hardware dependent software program and a hardware independent software program into a robot including a combination of a plurality of hardware configuration elements, and includes a hardware independent software program providing step for providing the hardware independent software program, a hardware dependent software program providing step for providing at least one hardware dependent software program, a hardware configuration information acquisition step for acquiring hardware configuration information of the robot, a hardware dependent software program selection step for selecting a hardware dependent software program, compatible with the hardware configuration information acquired in the hardware configuration information acquisition step, and provided in the hardware dependent software providing step, and a software introduction step for introducing, into a system, the hardware independent software program provided in the hardware independent software program providing step, and the hardware dependent software program selected in the hardware dependent software selection step.”

3. “The present invention in a third aspect relates to a robot control system which controls a robot including a combination of a plurality of hardware elements using a hardware dependent software program and a hardware independent software program, wherein the hardware independent software program and/or the hardware dependent software program is provided by a memory device which is permanently fixed to the body of the robot and a memory device which is replaceably mounted to the body of the robot, wherein the robot control system controls the robot in one of a best match operation mode, an intercompatible operation mode, and a fixed operation mode, and wherein in the best match operation mode, the robot is controlled using the hardware dependent software program and the hardware independent software program introduced from the exchangeable memory, in the intercompatible operation mode, the robot is controlled using the hardware dependent software program introduced from the fixed memory device and the hardware independent software program introduced from the exchangeable memory device, and in the fixed operation mode, the robot is controlled using the hardware dependent software program and the hardware independent software program introduced from the fixed memory device.”

The article “Sensor-based robot motion generation in unknown, dynamic and troublesome scenarios”, J. Minguez, L. Montano, Robotics and Autonomous Systems 52 (2005), pp. 290-311, is relevant to the state of the related art. The article is about:

1. an autonomous navigation system of robots for “robust and trustworthy navigation in very complicated environments”;

1.1. “e.g., robots that transport dangerous materials”;

2. that “the sensor-based motion control subsystem was developed to move the vehicle to the desired positions” (i.e. from point A to point B) “without collisions. This functionality is only a subset of the complete mobility problem”;

3. the environment of the robot; the environment, which is relevant for the article, are obstacles, which move around the robot;

4. that the robot computes over and over again a path from the robot location to the destination with help of three arts of modules in a troublesome environment (in a troublesome dynamic changed environment as well);

5. that the techniques, which are described in the article, “would increase the degree of autonomy of the robots and reduce human intervention”;

6. that the authors “. . . present a sensor-based motion control system as a subset of a complete navigation system”.

“Sensor and actuator abstraction and aggregation in a hardware abstraction layer for a robot” are known from American patent (US 2003/0171846 A1).

1. That patent is about hardware driver for robot, which are installed “between robot control software and underlying robot hardware and/or an operating system for the hardware”:

1.1. “In particular, the invention relates to a hardware abstraction layer (HAL) that enhances portability of control or behavior software”, which “permits robot control software to be written (by developers) in a robot-independent manner” and “efficiently permits robot control software developed for one robot to be ported to another”;

1.2. HAL implements resource software drivers, which are installed between “the lower-level device drivers” and “the higher-level robotic software with real-world measurements relating to robot interaction with an environment”, “wherein the higher-level software includes at least one selected from the group consisting of a planner, an application, a behavior, and a task”;

1.3. “one embodiment includes a computer-readable medium having computer-executable instructions for performing the method of providing hardware abstraction. The computer-readable medium can correspond to a wide variety of mediums including, but not limited to, hard disks, floppy disks, and other magnetic disks, RAM, ROM, Flash Memory, Memory Cards, and other solid-state memory, optical disks, CD-ROMs, DVD-ROMs, and the like”;

1.4. the “IResourceDriver”, “IResource”, “IRSensor”, “IResourceContainer” oder “Implemenmented Resource Interfaces” (“IAudioBase”, “IAudioLever”, “ICamera”, “ICamera Group”, “IBumpSensor”, “IRangeSensor”, “ISpitalSEnsor”, “IFace”, “IMotorCommand”, “IMotorQuery”, “IDriveSystem”, “Odometry”, “IImageDisplay”, “IJoystick”, “ISwitchDevice”, “IGripper”, “ISpeechRecognizer”, “ISpeechTTS”, “IPollable”, “ITransactable”) etc. are developed in a programming language (C++);

2. the invention generally relates to robotics and makes it possible that a robot can physically execute a robot task, for example, to go, to pick up or to smile or also for example in order that the robot dog can physically execute “to wag its tail”.

A non-linear genetic process for use with plural co-evolving populations is known from American patent (U.S. Pat. No. 5,148,513 A). That invention is about:

1. computer programs, source code, “Expressions such as (-(*5 4) (*3 2)) in LISP are called symbolic expressions (S-expressions)”; “It is helpful to graphically depict a functional programming language's expressions”;

2. programming language LISP, “This seeming simplicity gives LISP enormous flexibility (including the flexibility to accommodate computational procedures which modify themselves and execute themselves). This enormous flexibility makes LISP the preferred computer language for the present invention”;

3. computer programs, that are represented as entities, for example, “FIG. 12 illustrates a simple entity, namely the symbolic expression in the LISP programming language for the mathematical expression A+B*C”;

4. “populations of programs of various sizes and structures and wherein more than one program can be executed simultaneously” parallel in an environment;

5. “co-evolution” process of the populations of the computer programs, “The atom set and function set for the “co-evolution” process is the same as for the “non-linear genetic process””;

6. “co-evolution” process of the populations of the computer programs with (“co-evolving”) “of populations as the evolving population” of the computer programs and “the remaining populations” of the computer programs;

7. that the invention can be used, for example, in computer games, where a highly competent player needs the computer game difficult configured, or rather for an optimal strategy of player, “Co-evolution is likely to be especially important in competitive situations (i.e. games) because one almost never has a priori access to an optimal strategy for either player”.

The Universal machine translator of arbitrary languages is known from American patent (U.S. Pat. No. 6,341,372). That invention is about a thinking machine for translation of arbitrary languages (indirectly about androidal forms of existence and the artificial intelligence), the Universal Epistemological Machine (U.M.), the Modal Realization System (MRS), the general resultant modules (Rg module), the Rg continuum etc.:

1. “The TRS” (the translation system) “thus parses arbitrary source language syntax A for decomposition into the U. G.” (the universal grammar) “structures of the invention (epistemic instances), translates epistemic instances derived from A to epistemic instances derived from language B and then constructs the syntax and word streams of language B. This method, embodied in appropriate electronic or other apparatus, in conjunction with techniques of voice and character synthesis (generation) and recognition thus achieves an universal machine translator of language analogously to the way in which a human translator would translate language (ideally)—on the basis of the translation of the meanings of the languages involved”;

2. “Knowledge, the appearance of the mind's objects, is what is enabled as the form of consciousness; to the knower, it is an epistemic instance of a cognitive universe—a thought. Perception is the appearance to us of the world's objects; it is also an epistemic instance but of the corporal sensation of the world around us. Any form is an instance of our knowing and perceiving of the world around us, arising from beyond our knowing, as a state of being, or Soul”;

3. “. . . a language construction of human existence may objectify the universe in, for example, the use of ten or even twenty word compositions as subjects of sentences before proceeding cognitively to the transformation, or verb, of the sentence with one other such objectification, the androidal faculty of mind is capable of cognitively formulating objects of the universe, in any languages, in objectifications of the universe (word associations) composed so great in number they require the mathematical definitions of the infinite to account for them, before proceeding to the action (verb) of a sentence”;

4. “To do this, the machine compares the word forms, successively, to an embodiment (database) DB1 (277) of preexisting associations between the word form in its sensory/motor (real communicative) form and its possible grammatical arrangements in the source languages' grammar. The machine thus identifies the word forms in succession with their grammatical equivalents until a rule truncates the incoming word stream upon recognition of a high-level construction”.

That Universal Epistemological Machine does not physically substantiate the received signal-reaction of a cyborg or an android, the corresponding association of a cyborg or an android, and the corresponding thought of a cyborg or an android. The received signal-reaction of a cyborg or an android is not signals of sensors of a sense, the association of a cyborg or an android is not only a “word association”, the thought of a cyborg or an android is not a sentence. The Universal Epistemological Machine works with its “word associations” in two or more natural languages, but a system of Artificial Intelligence of a cyborg or an android does not. The Epistemology and the Computer Science (meaning area of class-based model of OOP) are different fields of science.

The linguistic object model is known from American patent (U.S. Pat. No. 7,171,352). That patent is about a programming language (a computer language) (SPL) and a framework of that programming language (of that computer language) (LOM):

1. “The present invention is a Linguistic Object Model (LOM), a semantic framework, and a semantic programming language (SPL) for producing natural language applications. The LOM models semantic utterances independent of the natural language used or the application domain involved”;

2. “The semantic programming language (hereinafter referred to as “SPL”) is intended to assist software application developers to implement natural language programs.” (For example, by developing software for mail agent (a e-mail program).) “Since most developers are not experts in semantic analysis or linguistics, the SPL provides a framework and a programming language for non-linguist developers to deal with natural language semantics in largely intuitive ways”;

3. “In general, the LOM is implemented as a class library of the SPL. This is similar to the way that the C Runtime Library and the Standard Template Library (STL) form the standard library of, for example, Microsoft.RTM. Visual C++.RTM., which is an application designed to facilitate software development and which was created by Microsoft Corporation of Redmond, Wash. The terms Microsoft.RTM. and Visual C++.RTM. are trademarks owned by Microsoft Corporation of Redmond, Wash.”;

4. “In one embodiment, the framework” (of the semantic framework of a semantic programming language (SPL)) “types are implemented as types in the NET Framework, which is a framework that was created by Microsoft.RTM. Corporation of Redmond, Wash.”;

5. The SPL is an object-oriented computer language;

6. computer program code of a computer language (SPL), for example:

6.1. “Entity BookEntity denoted by “book” {on resolve{with frame discuss<DoneTo.what:=string>;}}”;

6.2. “SendMailCommand uses SendMailFrame {on resolve{on begin{return Outlook.IsInSendMailContext( ); } on success {Outlook.SendMail(SendMailFrame.Mail, SendMailFrame.Targets);} on failure {// do whatever cleanup is necessary }}}”.

The field of that patent is not AI (the Artificial Intelligence). The theme of the patent is not a computer system of Artificial Intelligence of a cyborg or an android. The principal topic of that patent are not the received signal-reaction of a cyborg or an android, the corresponding association of a cyborg or an android, and the corresponding thought of a cyborg or an android. That patent is not about the thought substance of a cyborg or an android to the corresponding association substance of a cyborg or an android as well as the thought substance of a cyborg or an android is not a word or a semantic utterance.

“Method and system for automatic computation creativity and specifically for story generation” are known from American patent (U.S. Pat. No. 7,333,967). That patent is about a computer system and the method, which generates a story automatically, indirectly about the computational engines, termed the “creative agent”, about “the foundation for engineering creative agents that generate interesting stories, scripts, adventure games, musical compositions, recipes, paintings, sculptures etc.”, about FLEX, an expert rule-based system toolkit (fuzzy logic) “based in the programming language Prolog. It is commercially available from Logic Programming Associates, Ltd., incorporated in the United Kingdom”:

1. “Generally, a story is a natural language description of objects, their attributes, relationships, behaviors and interactions . . . However, all stories include a description of some set of objects and their interactions”;

2. “Objects described in the domain knowledge-base are interrelated and linked to linguistic concepts (e.g., words, phrases, etc.) as one way of capturing literary knowledge. The resulting associations between concepts and language elements are called “literary associations”. They are used to generate sentences that satisfy specific literary objectives”;

3. “FLEX provides the developer with complete access to Prolog” (Prolog is a computer language) “and enhances the paradigm with frame-based structures, relations, production rules, and an English-like syntax”;

4. converting some “formal, logic based language independent of a spoken language,” language representations to a natural language;

5. “Domain knowledge (e.g., 100A1) encodes a formal representation of objects, attributes, relationships, goals, behaviors, and events (e.g., a formal description of a domain). Domain knowledge is not the story itself, but is a description of a collection of concepts about which some story may be written”;

6. “The final level in the grammar hierarchy is composed of literary-augmented sentence grammars (LAGs), which are formal language grammars that represent components of English syntax augmented with literary constraints.”

The principal topic of that patent is not a computer system of Artificial Intelligence of a cyborg or an android. That patent is not about the received signal-reaction of a cyborg or an android, the corresponding association of a cyborg or an android, and the corresponding thought of a cyborg or an android. A “literary association” is not an association of a cyborg or an android. The toolkit of that patent (meaning a framework) works in a formal language. A formal language is not a natural language.

With only know-how of the American patent (U.S. Pat. No. 6,341,372) and of the American patent (U.S. Pat. No. 7,171,352) and also with American patent (U.S. Pat. No. 7,333,967) nobody can realize the received signal-reaction of a cyborg or an android, the corresponding association of a cyborg or an android, and the corresponding thought of a cyborg or an android, consequently the computer system, in which a received signal-reaction of a cyborg or an android, an association of a cyborg or an android, a thought of a cyborg or an android are physically substantiated. (Only a word or only a semantic utterance or only a sentence are not the received signal-reaction of a cyborg or an android or the corresponding association of a cyborg or an android or the corresponding thought of a cyborg or an android.)

Besides for example, the thought substance of a cyborg or an android, which points to the words of the vocabulary of the computer system of Artificial Intelligence of a cyborg or an android, and, the received signal-reaction of a cyborg or an android, which points to all the received signal-reactions of all n sense organs, and therefore knows the Environment (Surroundings), need to be referenced and synchronized. In the current invention, it is solved with the association substance of a cyborg or an android. For example, from my patent application “Pointer-oriented object acquisition method for abstract treatment of information of the computer system of Artificial Intelligence of a cyborg or an android based on one natural language”, patent application (DE 10 2006 052 141 A1, U.S. Ser. No. 11/727,322, IL 182773): “The third pointer does not refer to the associative object of computer system. It is the task of the cyborg-interpreter both of these pointers, the third and the second, to reference and to synchronize. The cyborg-interpreter is working in the one natural language, for example German or English. Therefore, the reference of the abstract object, i.e. of the third pointer, get no access to the associative object, i.e. to the second pointer, i.e. even with help of the cyborg-interpreter.”

From the American patent (U.S. Pat. No. 7,672,922 B2) and the patent applications (DE 10 2006 052 141 A1, IL 182773), a pointer-oriented object acquisition method for abstract treatment of information of the computer system of Artificial Intelligence of a cyborg or an android is known. That pointer-oriented object acquisition method for abstract treatment of information of the computer system of Artificial Intelligence of a cyborg or an android is based on one natural language. That patent is about, that by the pointer-oriented object acquisition method for abstract treatment of information of the computer system of Artificial Intelligence of a cyborg or an android which is based on one natural language three pointers are created in the computer main memory (in RAM (Random Access Memory)) of the computer system of Artificial Intelligence of a cyborg or an android in the natural language, in which the computer system is working at this timeframe, at run-time, in a way of the thinking paradigm of the class-based model of OOP, or rather of the programming language C++, as in instantiating an object on the Heap (the freely available memory storage area by dynamic memory allocation). In this way, the subjective object, the associative object, and the abstract object of the computer system of Artificial Intelligence of a cyborg or an android are instantiated and initialized. With those objects, which are implemented in the one natural language, one can access to, i.e. manipulate with the element variables, i.e. with the data elements, of a class of the classification tree of the computer system of Artificial Intelligence of a cyborg or an android. With the subjective object, a received signal-reaction of a cyborg or an android is physically substantiated in the computer system of Artificial Intelligence of a cyborg or an android, in the sense of building a substance of the signal-reaction. With the associative object, an association of a cyborg or an android is physically substantiated in the computer system of Artificial Intelligence of a cyborg or an android, in the sense of building a substance of the association. With the abstract object, a thought of a cyborg or an android is physically substantiated in the computer system of Artificial Intelligence of a cyborg or an android, in the sense of building a substance of the thought.

From the Israel patent (Pat. No. IL 175533) and the patent applications (DE 10 2005 054 901.2, U.S. Ser. No. 11/368,422), a working method for treatment of abstract objects (the thought substances) of the computer system of Artificial Intelligence of a cyborg or an android is known. That patent application is about a working method for the treatment of an abstract object of the computer system of Artificial Intelligence of a cyborg or an android, in which an abstract object (a thought substance) is compared with the other abstract objects (the other thought substances). The working method is impelled by the computer system by itself. The abstract objects (the thought substances) and/or the classes of the abstract objects are processed in a no permanent, in the sense of a no continuous treatment mode, that means discretely, for each abstract object (each thought substance). The abstract objects and the classes of the abstract objects are classified by the computer system by itself subjectively (in the sense of depending on the subject (on the computer system of Artificial Intelligence of the cyborg or the android)) in one natural language only if the class of the objects is a verb in the one natural language. The treatment mode is determined with the polymorphy of the classes classification of the computer system of Artificial Intelligence of the cyborg or the android. The decision, whether an abstract object is to be treated and how the abstract object is to be handled within the bounds of the determined treatment mode, is determined with the classes classification of the computer system of Artificial Intelligence of the cyborg or the android. With the working method more than ten internal directives of the abstract subjectivity of the computer system can be used.

Please take into consideration, if a cyborg or an android heard the rule “If that and that is the case, then that and that is the case”, then the following would happen.

First of all, the words would be summarized with the appropriate signal-reactions under a signal-reactions substance (a subjective object):

If that and that is the case, then that and that is the case.see;

If that and that is the case, then that and that is the case.hear;

If that and that is the case, then that and that is the case.smell;

If that and that is the case, then that and that is the case.taste;

If that and that is the case, then that and that is the case.touch;

. . .

If that and that is the case, then that and that is the case.n-sense.

Secondly, an association substance (an associative object) would be created to the signal-reactions substance, that means, the association substance to the corresponding signal-reactions substance.

Thirdly, a thought substance (an abstract object) would be created to the association substance, that means, the thought substance to the corresponding association substance. In this example two thought substances (“is” and “is”) of the class “Be” would be created. The thought substances would be compared with the other thought substances . . . (The thought substances would not be the “is” and “is”, but rather the “be” and “be”, because “If that and that does be the case, then that and that does be the case” would be understood . . .)

The article “Interfacing Silicon Nanowires with Mammalian Cells”, Woong Kim, Jennifer K. Ng, Miki E. Kunitake, Bruce R. Conklin, Peidong Yang, ACS PUBLICATIONS, Journal of the American Chemical Society (JACS), Published on Web: May 22, 2007, pp 7228-7229, is relevant to the state of the related art. This article is about an example of the interface from a computer system of Artificial Intelligence to a human body.

1. “We present the first demonstration of a direct interface of silicon nanowires with mammalian cells such as mouse embryonic stem (mES) cells and human embryonic kidney (HEK 293T) cells without any external force. The cells were cultured on a silicon (Si) substrate with a vertically aligned SiNW array on it. The penetration of the SiNW array into individual cells naturally occurred during the incubation. The cells survived up to several days on the nanowire substrates. The longevity of the cells was highly dependent on the diameter of SiNWs. Furthermore, successful maintenance of cardiac myocytes derived from mES cells on the wire array substrates was observed, and gene delivery using the SiNW array was demonstrated. Our results suggest that the nanowires can be potentially utilized as a powerful tool for studying intra- and intercellular biological processes.”

The project “BBCI—An interface between brain and computer” is relevant to the state of the related art. “Project directors: Prof. Dr. Klaus-Robert Muller, Prof. Dr. Gabriel Curio, Dr. Benjamin Blankertz.”

1. “For several years, research groups in Europe and the USA have been working on systems which allow for a direct dialog between man and machine. To this end, a “Brain Computer Interface” (BCI) has been developed. Cerebral electric activity is recorded via the electroencephalogram (EEG): electrodes, attached to the scalp, measure the electric signals of the brain. These signals are amplified and transmitted to the computer, which transforms them into device control commands. The crucial requirement for the successful functioning of the BCI is that the electric activity on the scalp surface already reflects motor intentions, i.e., the neural correlate of preparation for hand or foot movements. The BCI detects the motor-related EEG changes and uses this information, for example, to perform a choice between two alternatives: the detection of the preparation to move the left hand leads to the choice of the first, whereas the right hand intention would lead to the second alternative. By this means it is possible to operate devices which are connected to the computer; such a communication can even be realised via the internet.”

2. “The project (BMBF Förderzeichen 01KO0121, 01IBB02A/B, 01IBE01A/B), which is supported by the ministry for education and research (Bundesministerium für Bildung and Forschung, BMBF), comprises the development of EEG-driven systems for computer-aided working environments. These systems will, for instance, allow for the control of a mouse pointer by means of brain waves. Furthermore, medical tools are being created for patients suffering from amyotrophia or quadriplegia.”

3. “This research program is done in a cooperation between the Berlin Institute of Technology, Machine Learning Laboratory (Prof. Dr. Klaus-Robert Müller and Dr. Benjamin Blankertz), Fraunhofer FIRST institute, research group IDA (Intelligent Data Analysis) (Prof. Dr. Klaus-Robert Müller and Dr. Benjamin Blankertz), and the neurophysics research group, Department of Neurology at Campus Benjamin Franklin, Charité—University Medicine, Berlin, (Prof. Dr. Gabriel Curio).”

The “BrainGate(™) Neural Interface System”, a product of Cyberkinetics, Inc. is relevant to the state of the related art. The interface was described, for example, in article “Industry Shorts—Nexus: Cyberkinetics Initiates Pilot Study of BrainGate Neural Interface System”, Robotics Trends, Robots and Robotics Technology News, Information and Analysis, Published on Web: Wednesday, Apr. 21, 2004-07:23 PM, Copyright 2004 Business Wire, Inc.; Copyright© 2002 LexisNexis, a division of Reed Elsevier Inc.

1. “FOXBOROUGH, Mass., Apr. 20, 2004—Cyberkinetics, Inc. today announced that it has initiated a pilot study of the investigational BrainGate(™) Neural Interface System.”

2. “About the BrainGate(™) System:

Cyberkinetics' BrainGate Neural Interface System is a proprietary, investigational brain-computer interface device that consists of an internal neural signal sensor and external processors that convert neural signals into an output signal under the person's own control. The sensor consists of a tiny chip about the size of a baby aspirin, with one hundred electrode sensors each thinner than a hair that detect brain cell electrical activity. The sensor will be implanted on the surface of the area of the brain responsible for movement, the primary motor cortex. The sensor will be connected by a small wire to a pedestal which will be mounted on the skull, extending through the scalp. The pedestal will be connected by a cable to a cart containing several computers and monitor which will enable the study operators to determine how well a patient can control their neural output.”

3. “About Cyberkinetics, Inc.

Cyberkinetics is a leader in neurotechnology, an emerging field driven by advances in neuroscience, computer science, and engineering that promises to revolutionize the medical treatment of nervous system dysfunction. Cyberkinetics' first product, BrainGate(™), is designed to give severely paralyzed patients a long-term, direct brain-computer interface for the purpose of communication and control of a computer. Cyberkinetics' intellectual property features key technologies licensed from Brown University, the Massachusetts Institute of Technology, Emory University, and the University of Utah. Cyberkinetics is headquartered in Foxborough, Mass. and conducts engineering and research in Salt Lake City, Utah.”

The three interfaces are some examples of the interfaces of the computer system of Artificial Intelligence to the human body, or rather to the cyborg body. That means that the computer system of Artificial Intelligence becomes the computer system of Artificial Intelligence of a cyborg with one of these interfaces.

Further, the humanoid robots are known which can move in human or animal way.

For example, ASIMO is a robot developed by company Honda which can move in human way.

The AIBO of company Sony, a robot-dog, which can be programmed. In addition, he can run, see, show his feelings and speak the predefined words.

The QRIO of company Sony. It is a humanoid robot itself, which can move in human way. He can do everything that the AIBO can do. He can also speak about something, or have a conversation. Besides, the speech recognition is used and the predefined response scenarios with many thousands of words are prepared. In addition, the QRIO is very expensive.

Further, the predicate logic is worldwide known. It plays a big role in informatics for the programming of expert's systems and Artificial Intelligence. It is based on the logical predicate, which can take part as either a property or a relation between entities, but not as an action. The predicate is considered as not object-oriented. Neither the subject term nor the predicate term are considered relative to time.

Some terms need to be defined for describing the present invention. The terms and their definitions include:

1. Android:

1.1. “Android der, -en/-en, Androide der, -n/-n ein zu bestimmten Tätigkeiten fähiger→Automat in Menschengestalt” (An android is→an automatic machine which is capable to the determined activities in the human shape) (The encyclopedia “Brockhaus-Enzyklopädie”: in 24 vol.-19., fully revised Edition, F. A. Brockhaus GmbH, Mannheim 1986, ISBN 3-7653-1101-4/3-7653-1201-0; page 562).

1.2. “An android is an artificially created robot, an automation, that resembles a human being . . . in . . . behavior. The word derives from the Greek andr-, “meaning “man, male”, and the suffix-eides, used to mean “of the species alike” (from eidos “species”).“—Wikipedia, the free encyclopedia. htm (http://en.wikipedia.org/wiki/Android);

1.2.1. Unlike the terms robot (a “mechanical” being) and cyborg (a being that is partly organic and partly mechanical), the word android has been used in literature and other media to denote several different kinds of artificially constructed beings:

1.2.1.1. a robot that closely resembles a human;

1.2.1.2. a cyborg that closely resembles a human;

1.2.1.3. an artificially created, yet primarily organic, being that closely resembles a human.

2. Cyborg:

2.1. “Cyborg ['saibo:g; Kw. aus engl. cybernetic organism >kybernetisches Lebewesen<] der, -s/-s, in der Futurologie Bez. für einen Menschen, in dessen Körper techn. Geräte als Ersatz zur Unterstützung nicht ausreichend leistungsf\ddot{ä}higer Organe (z.B. für lange Raumflüge) integriert sind” (Cyborg [from engl. cybernetic organism] in futurology a term for a human being in whose body some technical devices are integrated as substitution for support of the insufficiently efficient organs (for example for long space-flights)) (The encyclopedia “Brockhaus-Enzyklop\ddot{ä}die”: in 24 vol.-19., fully revised Edition, F. A. Brockhaus GmbH, Mannheim 1988, ISBN 3-7653-1105-7/3-7653-1205-3; page 67).

2.2. “The term cyborg, a portmanteau of cybernetic organism, is used to designate an organism which is a mixture of organic and mechanical (synthetic) parts . . . ”—Wikipedia, the free encyclopedia.htm (http://en.wikipedia.org/wiki/Cyborg);

2.2.1. Generally, the aim is to add to or enhance the abilities of an organism by using technology, i.e. a man-machine mixture;

2.2.2. “Isaac Asimov's short story “The Bicentennial Man” explored cybernetic concepts . . . His explorations lead to breakthroughs in human medicine via artificial organs and prosthetics.” As well as to the “ . . . artificial positronic brain . . . ”;

2.2.3. “The term “cyborg” is used to refer to a man or woman with bionic, or robotic, implants.”

3. Strong Artificial Intelligence:

3.1. In the philosophy of artificial intelligence, strong Artificial Intelligence is the claim that some forms of artificial intelligence can truly reason and solve problems; strong Artificial Intelligence states that it is possible for machines to becomes sapient, or self-aware, but may or may not exhibit human-like thought processes.—Wikipedia, the free encyclopedia.htm (http://en.wikipedia.org/wiki/strong_AI);

3.2. “according to strong AI, the computer is not merely a tool in the study of the mind; rather, the appropriately programmed computer really is a mind” (J. Searle in Minds, Brains and Programs. The Behavioral and Brain Sciences, vol. 3, 1980).“—Wikipedia, the free encyclopedia.htm (http://en.wikipedia.org/wiki/strong_AI);

4. “The mind is the term most commonly used to describe the higher functions of the human brain . . . ”—Wikipedia, the free encyclopedia.htm (http://en.wikipedia.org/wiki/Mind).

5. In psychology . . . two concepts or stimuli are associated when the experience of one leads to the effects of another, due to repeated pairing. This is sometimes called Pavlovian association for Ivan Pavlov's pioneering of classical conditioning.—Wikipedia, the free encyclopedia.htm (http://en.wikipedia.org/wiki/Association_%28psychology%29).

6. Thought:

6.1. “The thought is a direct sense shape of thinking . . . the thought describes a result, a product of the thinking-process.”—Wikipedia, the free encyclopedia.htm (http://de.wikipedia.org/wiki/Gedanke).

6.2. “It (thought) is an element/instance of thinking and is used as its synonym.” “In philosophy, thought is also a synonym for idea.”—Wikipedia, the free encyclopedia.htm (http://en.wikipedia.org/wiki/Thought_(disambiguation)).

7. Abstract thinking:

7.1. “abstraktes Denken, Denkprozess, durch den sich losgelöst (abstrahiert) von komplexen

Sachverhalten bestimmte Aspekte verallgemeinern lassen” (abstract thinking, thinking process, with which the particular aspects unbound (abstracted) from the complex facts can be generalized) (The lexicon “Lexikon der Psychologie”: in 5 vol, editor: Gerd Wenninger—Heidelberg; Berlin: Spektrum, Akademischer Verlag GmbH, Heidelberg 2000, vol. 1. A to E, ISBN 3-8274-0312-X; page 9).

7.2. “Abstraktion die , -/-en, Denkvorgang bei der Bildung von Begriffen and Gesetzen, gekennzeichnet durch das stufenweise Heraussondern bestimmter Merkmale in der Absicht, das Gleichgebliebene und Wesentliche versch. Gegenstände zu erkennen; auch das Ergebnis des A.-Prozesses. Bei der generalisierenden A. werden die relevanten gemeinsamen Merkmale versch. Gegenstände oder Klassen herausgehoben, wobei von den unwesentlichen, sich unterscheidenden abgesehen wird” (Abstraction, thinking process, characterized by gradual separating particular attributes, during the definition of terms and laws, with intent to identify the unchanged and significant of particular objects; also the result of the A.-process. With the generalized A., the relevant general attributes of particular objects or classes are selected, and the irrelevant different attributes are irrespective.) (The encyclopedia “Brockhaus-Enzyklopädie”: in 24 vol.-20., fully revised Edition, F. A. Brockhaus GmbH, Mannheim 1996, vol. 1. A-AP, ISBN 3-7653-3100-7/3-7653-3101-5; page 84).

7.3. “Abstraktion, auf zufällige Einzelheiten verzichtende, begrifflich zusammengefaβte Darstellung; Vorgang und Ergebnis des Auswählens eines ganz bestimmten Aspekts eines komplexen Sachverhaltes, um diesen zu klassifizieren, zu bewerten und zu verallgemeinern” (Abstraction, conceptually generalized definition, abstaining from irrelevant details; process and result of selection of a quite particular aspect of a complex fact, in order to classify, to estimate and to generalize) (The lexicon “Lexikon der Psychologie”: in 5 vol, editor: Gerd Wenninger—Heidelberg; Berlin: Spektrum, Akademischer Verlag GmbH, Heidelberg 2000, vol. 1. A to E, ISBN 3-8274-0312-X; page 9).

7.4. “Abstraction is the process or result of generalization by reducing the information content of a concept or an observable phenomenon, typically in order to retain only information which is relevant for a particular purpose. For example, abstracting a leather soccer ball to a ball retains only the information on general ball attributes and behaviour.”—Wikipedia, the free encyclopedia.htm (http://en.wikipedia.org/wiki/Abstract_thinking).

8. Capacity for abstract thought:

8.1. “Abstraktionsvermögen→. . . : das; -s; -(geistige) Fähigkeit, aus dem Besonderen etw. Allgemeines abzuleiten” ((intellectual) ability to derive something general from the particular) (The dictionary “Deutsches Wörter-Buch”; Karl-Dieter B\ddot{ü}nting, Isis Verlag A G, 1996, Chur/Schweiz, page 38).

9. Telepathy:

9.1. “Telepathy (from the Greek τ□λε, tele, “distant”; and παθεια, patheia, “feeling”) is defined in parapsychology as the paranormal acquisition of information concerning the thoughts, feelings or activity of another person.”—Wikipedia, the free encyclopedia.htm (http://en.wikipedia.org/wiki/Telepathy).

9.2. “The German Term for Telepathy is the Thoughts-Transfer.”—Wikipedia, the free encyclopedia (http://de.wikipedia.org/wiki/Telepathie).

10. “The most popular and developed model of OOP is a class-based model, as opposed to an object-based model. In this model, objects are entities that combine state (i.e., data), behavior (i.e., procedures, or methods) and identity (unique existence among all other objects). The structure and behavior of an object are defined by a class, which is a definition, or blueprint, of all objects of a specific type . . . ”—Wikipedia, the free encyclopedia.htm (http://en.wikipedia.orq/wiki/Class-based OOP).

11. Pointer:

11.1. “A pointer identifies in computer science a special class of variables, that refer to another memory space or the variables itself . . . The referred memory space contains either data (object, variable) or the program code.”—Wikipedia, the free encyclopedia.htm (http://de.wikipedia.ora/wiki/Zeiger).

11.2. In C and C++, pointers are variables that store addresses (of the computer memory) and can be NULL. A NULL-Pointer has a reserved value, often but not necessarily the value zero, indicating that it refers to no object. (The NULL-Pointer stores the address of a NULL-Object, i.e. points to nothing). A pointer is a simple implementation of the general reference data type (although it is quite different from the facility referred to as a reference in C++).—Wikipedia, the free encyclopedia.htm (http://en.wikipedia.org/wiki/Pointer).

12. Reference:

12.1. “A reference represents an identification of an object. . . . Therewith, a reference represents an alias name to an entity.”—Wikipedia, the free encyclopedia.htm (http://de.wikipedia.orq/wiki/Referenz_%28Programmierunq%29).

12.2. A reference is an alias-name. When a reference has been created, it will be initialized with the name of another object, with the target. From this moment, the reference will be like an alternative name for the target, and everything that will be applied to the reference will, in fact, refer to the target. (The book “C++ in 21 Tagen”, Jesse Liberty, 2000 by Markt&Technik Verlag (Publishing), ISBN 3-8272-5624-0, the authorized translation of the American original edition: “Teach Yourself C++ in 21 Days”© 1999 by SAMS Publishing, page 290).

13. Object:

13.1. Therewith . . . the new objects are created on the heap (the freely available memory storage area by dynamic memory allocation). The . . . given back address (of the memory storage area) will be stored in the pointer. (The book “C++ in 21 Tagen”, Jesse Liberty, 2000 by Markt&Technik Verlag (Publishing), ISBN 3-8272-5624-0, the authorized translation of the American original edition: “Teach Yourself C++ in 21 Days”© 1999 by SAMS Publishing, pages 263, 264, 267, 285).

13.2. “Der Operator new erzeugt solche Objekte, und der Operator delete kann benutzt werden, um sie zu zerstören. Objekte, die durch new angelegt wurden, werden als >>im Freispeicher<< befindlich bezeichnet (und auch als >>Heap-Objekte<< oder >>im dynamischen Speicher angelegt<<)” (The operator “new” creates such objects, and the operator “delete” can be used to destroy them. The objects that were instantiated with “new” are defined as allocated >>in the freely available memory storage<< (as well as >>Heap-Objects<< or >>that are created by dynamic memory allocation<<)) (The book “Die C++-Programmiersprache”; 3. Edition; Bjarne Stroustrup (Der Erfinder von C++); Addison Wesley Longman Verlag (Publishing); 1998; ISBN 3-8273-1296-5; page 136; (the American original edition: “The C++-Programming Language”, Bjarne Stroustrup (The inventor of C++), Third Edition, Addison-Wesley, Reading, ISBN 0-201-88954-4 © 1997 AT&T)).

14. Database table as an array of pointers:

“Da das erstellte Formular der Beispielanwendung Informationen zu einer Person enthält, bietet es sich an, die neue Klasse CPerson zu nennen. Damit Sie die Klasse im Objektarray speichern können, müssen Sie die Klasse von CObject als Basisklasse ableiten.”

“Nach der gleichen Logik, . . . , nehmen Sie in der heutigen Beispielanwendung einen neuen Personendatensatz in das Objektarray der Dokumentklasse auf. Nachdem Sie einen neuen Datensatz hinzugefügt haben, können Sie einen Zeiger darauf zuruckgeben, so daβ die Ansichtsklasse direkt die Variablen im Datensatzobjekt aktualisieren kann.”

“Sobald der neue Datensatz hinzugefügt ist, setzen Sie den aktuellen Datensatzzeiger auf den neuen Datensatz im Array. Auf diese Weise läβt sich die aktuelle Datensatznummer leicht anhand des Positionszählers bestimmen.”

“For your sample application, because the form that you created has information about a person, you might want to call your class something like CPerson. To be able to hold your class in the object array, you need to give it CObject as the base class.”

“Following the same logic . . . , you should add a new person record to the object array in your document class in today's sample application. Once you add a new record, you can return a pointer to the new record so that the view class can directly update the variables in the record object.”

“Once the new record is added, you will want to set the current record position marker to the new record in the array. This way, the current record number can be easily determined by checking the position counter.”

Visual C++ 6 in 21 Tagen, Davis Chapman, Deutsche Übersetzung: Frank Langenau, 1998 by SAMS, Markt&Technik Buch- and Software-Verlag GmbH, ISBN: 3-8272-2035-1, pages 325, 333; Sams Teach Yourself Visual C++® 6 in 21 Days, Copyright© 1998 by Sams Publishing, ISBN: 0-672-31240-9, pages 288, 295, 296).

### OBJECTIVES OF THE INVENTION

The way of posing a problem of this invention is to realize the computer system of Artificial Intelligence of a cyborg or an android for the pointer-oriented object acquisition method for tangible treatment of information of this computer system which is based on one natural language. In this computer system of Artificial Intelligence, a received signal-reaction of the computer system of Artificial Intelligence of a cyborg or an android, an association of the computer system of Artificial Intelligence of a cyborg or an android, a thought of the computer system of Artificial Intelligence of a cyborg or an android should be substantiated. The computer system should be with its working method:

dependent on no hardware;

dependent on no operating system;

dependent on no computer language;

dependent on no code;

dependent on no software;

dependent on no software developer, by software developing;

dependent on no software developer, as a person, who considers all things with own subjectivity;

dependent on no database or another way to store data;

dependent on no the specific computer language column types, for example, Integer, Number,

Universal Unique Identifier, Global Unique Identifier, etc., for creating all primary keys of the database tables (in case of using one (or more) database(s)).

The computer system should be economical for the further development relative to both the hardware devices and the software components.

### BRIEF SUMMARY OF THE INVENTION

The innovative solution accomplished by the present invention is that a received signal-reaction of a cyborg or an android (a subjective object), an association of a cyborg or an android (an associative object), a thought of a cyborg or an android (an abstract object) are substantiated in the computer system of Artificial Intelligence of a cyborg or an android and that one natural language, which the computer system uses with its working method, is interpreted by the computer system as object-oriented. The computer system functionality is based on these objects, two of which (an association of a cyborg or an android and a thought of a cyborg or an android) are defined relative to time. These objects are no objects of a computer language. The objects are generated from the one natural language and classified according to an action in the one natural language. These objects generated by the natural language can represent some more reactions in each case from some more sensors groups than five reactions of five sense organs. The computer system uses the references to the thought of the computer system of Artificial Intelligence of a cyborg or an android (to the abstract object) for another language.

In details, summarizing follows the subjective first input of the incoming signals of the sensors groups by the computer system.

With subjective summarizing the incoming signals of the sensors groups by the computer system, a signal combination is created. Thus, a subjective object is determined for the computer system.

Then associative collecting the incoming signals of the sensors groups by the computer system to a phrase of one natural language follows. The combination of five incoming sensors groups signals with this phrase represents an associative object of the computer system. After processing by the cyborg-interpreter, this phrase is completed and defined relative to time, for example, it is provided with a timestamp. Associative collecting pursues goals that the associative object is completed, that it is stored uniquely for the long term, as well as that it can be found over and over again.

The phrase which contains the associative object is abstractly analyzed by the cyborg-interpreter at work. This phrase is parsed on the single words with abstract analyzing. Every parsed word is defined as the part of speech and/or as the part of a sentence. Then every word of the phrase will be analyzed abstractly, with regard to the class classification, the polymorphism, the units of measurement, the intonation. Then every word of the phrase will be stored uniquely for the long term, classified according to an action in the one natural language, with an analytic entity, with having consideration for the word order of the phrase, relative to time of summarizing the incoming signals of the sensors groups by the corresponding associative object. In this way, a phrase stored word by word represents an abstract object of the computer system.

The computer system operates with this abstract object at work.

Thus, for example, a new class is specified in the class classification according to inheritance or a new unknown object is polymorphically arranged to an existing class.

The abstract object can be found by the computer system over and over again. The associative object will be found corresponding to the abstract object. The subjective object will be found corresponding to the associative object.

The subjective object can be returned.

The subjective object will be split into the single signals of the sensors groups on its return, i.e., the output mode, output value, and output unit of measurement will be defined for every output interface of the sensors groups.

The computer system uses one natural language for the working method. For the working method in the first, original, natural language, the computer system can use references in another natural language to words in the first, original, natural language. But the references, i.e. the abstract objects in another natural language, in another natural language to the abstract objects in the first, original, natural language, are used by the computer system during the working method in the other natural language. The same logic will be used for several natural languages.

The subjective object (the received signals-reaction), the associative object (the corresponding association), the abstract object (the corresponding thought) are physically substantiated as the appropriate pointers.

That is that both the physical particular area of the computer memory where some data is allocated and the other physical particular area of the computer memory which points to the first one (the pointer in which the given back addresses of the computer memory are stored) have nothing to do with the software patents, a fragment of program code that is implemented in a computer language.

(I ask to be excused for the following such a primitive example.)

In the simplest case, this patent application is about a working method of the computer memory, for example, total primitively, of a computer memory module, for example of a Kingston computer memory module KVR667D2N5/1G.

The subjective object (the received signal-reactions substance) of the computer system of Artificial Intelligence of a cyborg or an android is not the input of a signal-reaction or n signal-reactions of n sensor groups. The subjective object (the received signal-reactions substance) of the computer system of Artificial Intelligence of a cyborg or an android is the first pointer in which the given back RAM (Random Access Memory) addresses of the inputs of all n reactions of all n sensor groups that represent all sense organs (or rather at least five sensor groups, the group of the sense of sight, the group of the sense of hearing, the group of the sense of smell, the group of the sense of taste, the group of the sense of touch and thereto all n groups from all n-sense organs sensor groups else) are stored.

The associative object (the association substance) of the computer system of Artificial Intelligence of a cyborg or an android is also the pointer in which the given back RAM (Random Access Memory) addresses are stored. That is that the subjective object, or rather the first pointer that is identified as the subjective object, after it has been completed associatively and relative to time will be stored in the RAM (Random Access Memory) of the computer system of Artificial Intelligence of a cyborg or an android at run-time as a second pointer that will be identified as the associative object (as the corresponding association of the computer system of Artificial Intelligence of a cyborg or an android).

The abstract object (the thought substance) of the computer system of Artificial Intelligence of a cyborg or an android is not a word or a semantic utterance or a sentence. The abstract object (the thought substance) of the computer system of Artificial Intelligence of a cyborg or an android is the pointer on the vocabulary of the computer system. The given back RAM (Random Access Memory) addresses of the computer memory area in which each word of the vocabulary of the computer system of Artificial Intelligence of a cyborg or an android is mapped are stored in this third pointer.

This invention, as also my inventions “Working method for treatment of abstract objects (the thought substances) of the computer system of AI (Artificial Intelligence) of a cyborg or an android”, patent application (DE 10 2005 054 901, U.S. Ser. No. 11/368,422, IL 175533), and “Pointer-oriented object acquisition method for abstract treatment of information of the computer system of Artificial Intelligence of a cyborg or an android based on one natural language”, patent application (DE 10 2006 052 141 A1, U.S. Ser. No. 11/727,322, IL 182773), is based on one of my scientific discoveries, and/or a theory of subjectivity, with the subject—“Human intelligence. Natural intelligence. The functionality of the human (natural) intelligence.”

The three inventions make it possible either the conversion of a humanoid robot into an android or the conversion of a human being into a cyborg with the artificial component, or with the artificial part,—the Artificial Intelligence.

An enormous gigantic job potential, which includes thousands of highly qualified, highly motivated, high-quality jobs in the different branches, is hidden behind this invention.

Except the use of the computer system and the working method as a computer system and a working method of this computer system of Artificial Intelligence of a cyborg or an android, the invention is susceptible of industrial application, for example:

1. in the manufacture of toys. In this way, a doll can be produced with a computer system of

Artificial Intelligence. The doll will communicate with the child actively. It can be used for education purposes. It can be used for teaching methods. It can be used as a friend for children . . .

2. in the medicine. Thus, a model of the central nervous system of a mentally ill or neurological ill patient can be implemented. The model will be used in the illness simulations and for the simulations of healing methods;

3. in the fight against crime. In this way, a model of the central nervous system of a criminal can be implemented. His steps can be pre-estimated with the model;

4. for counterterrorism. Thus, a model of the central nervous system of a terrorist can be implemented. Thus, the behavior and manners of the terrorists can be pre-estimated. Thus, for example, the future terrorist attacks can be prevented.

Other details, features and advantages result from the execution examples shown in the drawings, and from the independent and dependent claims. The execution examples follow the description.

### BRIEF DESCRIPTION OF THE DRAWINGS

In the drawings:

FIG. 1 shows a computer system of Artificial Intelligence of a cyborg or an android.

FIG. 2 illustrates the working method for the subjective first input of the incoming signals of the sensors groups by the computer system and subjective summarizing these signals to a subjective object.

FIG. 3 is an illustration of the working method for associative collecting the incoming signals of the sensors groups by the computer system relative to time to an associative object.

FIG. 4 illustrates the working method for abstract analyzing the abstract object of the computer system, abstract operating with the abstract object, abstract storing the abstract object and abstract finding the abstract object again.

FIG. 5 illustrates the working method for abstract transmitting back the abstract object of the computer system.

FIG. 6 illustrates the working method used by the computer system for working in another natural language or in several natural languages.

FIG. 7 shows some examples of the objects generated into the abstract objects in one natural language.

FIG. 8 shows some more examples of the objects generated into the abstract objects in one natural language.

FIG. 9 shows some more examples of the objects generated into the abstract objects in one natural language.

### DETAILED DESCRIPTION OF THE INVENTION

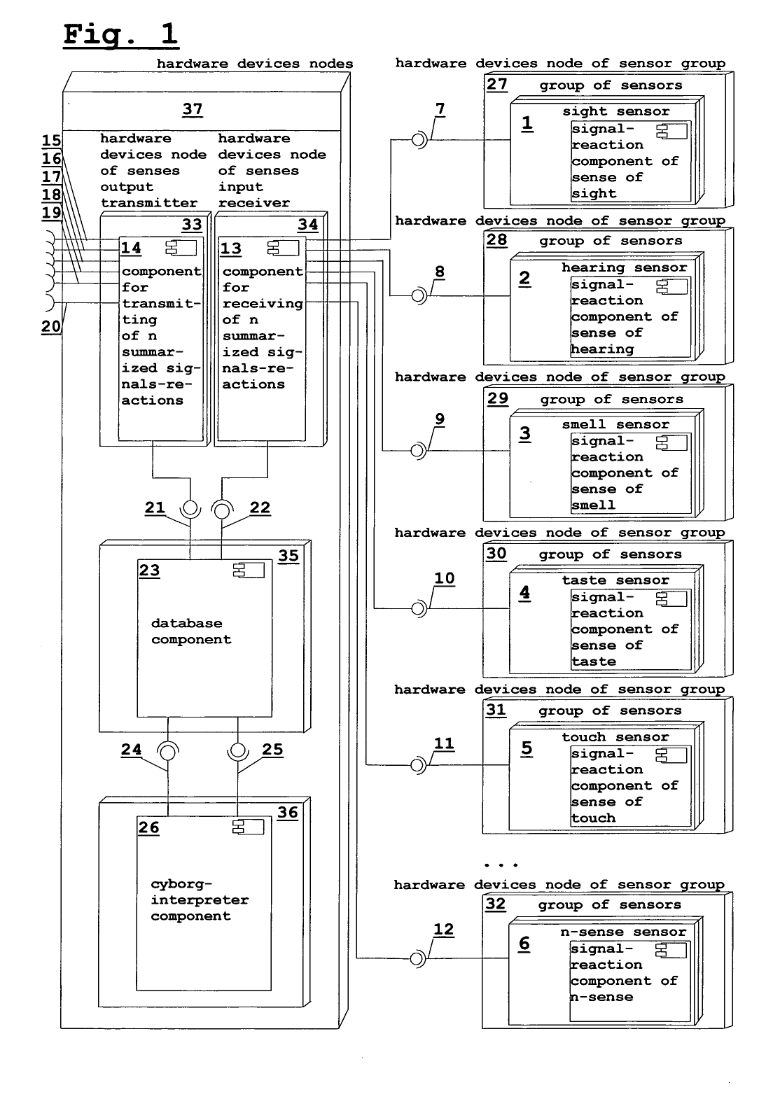

FIG. 1 shows a computer system of Artificial Intelligence of a cyborg or an android. Five sensors groups, the group of the sense of sight 1, the group of the sense of hearing 2, the group of the sense of smell 3, the group of the sense of taste 4, the group of the sense of touch 5, receive the incoming signals, summarize the signals to the particular signals, one from every group, i.e. a signal from the group of the sense of sight, a signal from the group of the sense of hearing, a signal from the group of the sense of smell, a signal from the group of the sense of taste, a signal from the group of the sense of touch, and transmit the signals at the same time. With the appropriate input interfaces, the seeing input interface 7, the hearing input interface 8, the smelling input interface 9, the degusting input interface 10, the touching input interface 11, the five signals come at the same time to the senses input receiver 13. The senses input receiver writes the five signals with the database input interface 22 at the same time to the database 23. The sixth sensors group demonstrates the sensors group of n-sense 6, as well as the sixth input interface demonstrates the input interface of n-sense 12. The cyborg-interpreter 26 accesses the data in the database with the interpreter input interface 24 and the interpreter output interface 25. The work results of the cyborg-interpreter are stored in the database. With the database output interface 21, with the senses output transmitter 14, and with the five output interfaces: the show output interface 15, the sound output interface 16, the scent output interface 17, the taste output interface 18, the touch output interface 19, the five prepared output signals are read at the same time from the outside. The sixth output interface demonstrates the output interface of n-sense 20. The hardware devices nodes are illustrated under the number 27, 28, 29, 30, 31, 32, 33, 34, 35, 36. They are implemented for the test and demo purposes as some different computers. The peripheral devices as well as the microcontrollers will be used for production. The internal hardware environment is illustrated under the number 37.

In another implementation, particular signals are stored with the senses input receiver on the hard disk into the signal data files and can be returned with the senses output transmitter. The names of the signal data files are written with the database input interface into the database and will be read with the database output interface from the database. In this case, the object of the sense organs (the received signal, or rather the received signal-reactions) is created from the names of the files. In this case also, all data is stored in the database only as a single data type, for example the character string. In this case, the computer system is independent of the database, or it needs a quite simple database.

The other drawings illustrate the working method of computer system of Artificial Intelligence of a cyborg or an android.

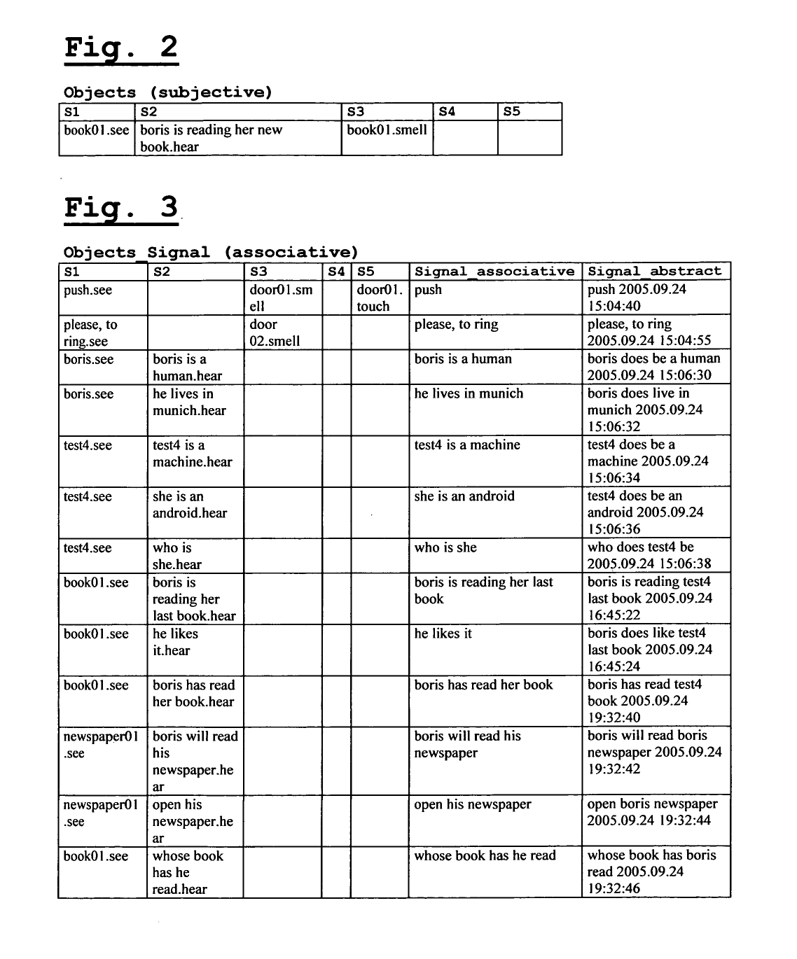

FIG. 2 illustrates the working method for the subjective first input of the incoming signals of the sensors groups by the computer system and subjective summarizing these signals to a subjective object. In details, summarizing follows the subjective first input of the incoming signals of the sensors groups by the computer system. With subjective summarizing the incoming signals of the sensors groups by the computer system, a signal combination is created. Thus, a subjective object is determined for the computer system. Five subjectively incoming signals are stored subjectively to the subjective object. S1 stands for the sense of sight signal, S2 stands for the sense of hearing signal, S3 stands for the sense of smell signal, S4 stands for the sense of taste signal, S5 stands for the sense of touch signal. The columns definition of the database gives the possibility to store an appropriate signal in every column. In another implementation, only the names of files are stored in the database. Every subjective object is unique. It will be stored in the database uniquely, relative to S1, S2, S3, S4, S5. It will be deleted from the database after the data processing.

(The table Objects (subjective) is implemented with the primary key relative to S1, S2, S3, S4, S5. The primary key of the table is created without the specific computer language column types, for example, Integer, Number, Universal Unique Identifier, Global Unique Identifier, etc. but with the column combinations from this table. The other database tables are created in the same way.)

FIG. 3 is an illustration of the working method for associative collecting the incoming signals of the sensors groups by the computer system relative to time to an associative object. The incoming, subjective, concrete object is described in one natural language, for example, as a Signal_associative, with a phrase. This phrase and the combination of five incoming sensors groups signals S1, S2, S3, S4 and S5 define an associative object. As a result of the work of the cyborg-interpreter this phrase is completed. It is also defined relative to time (for example is provided with timestamp and is stored as a Signal_abstract in the database). In addition, the associative object is stored for the computer system uniquely, relative to S1, S2, S3, S4, S5, the phrase and the relative definition of time, for the long term.

(The table Objects_Signal (associative) is implemented with the primary key relative to S1, S2, S3, S4, S5, and for example Signal_abstract, i.e., the timestamp does not need to be unique as well. (The primary key of this table is created without the specific computer language column types, for example, Integer, Number, Universal Unique Identifier, Global Unique Identifier, etc. but with the column combinations from the table.) The other database tables are created in the same way.)

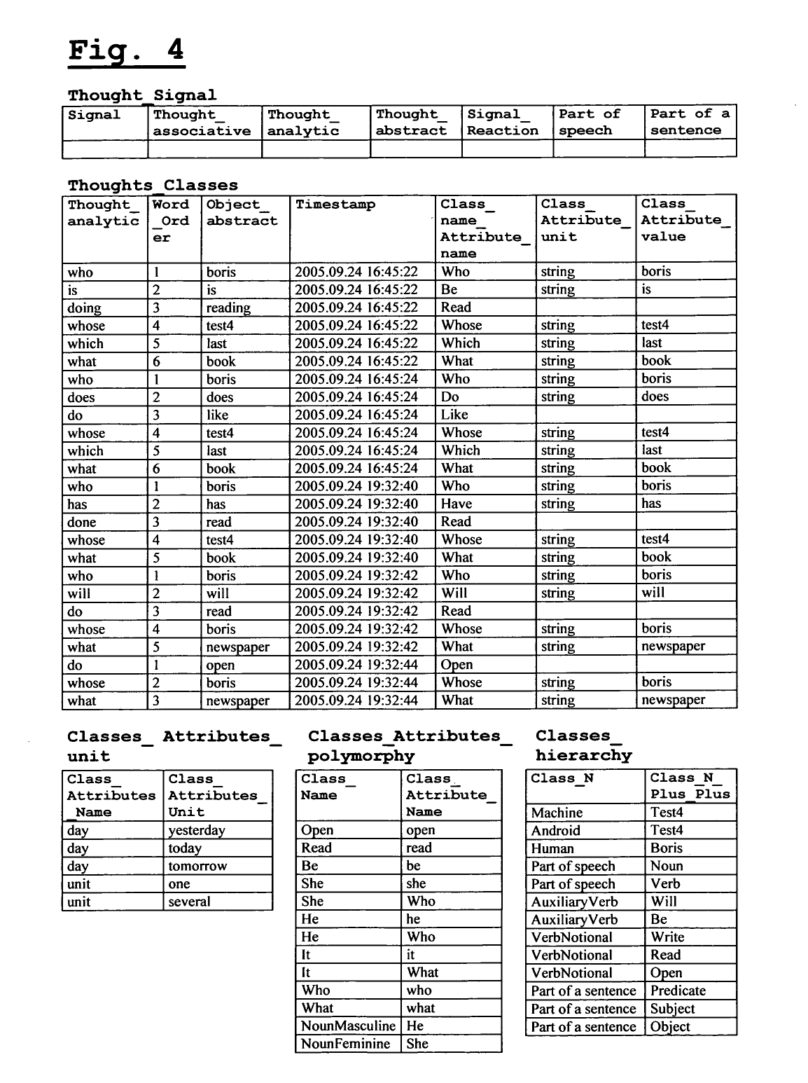

FIG. 4 illustrates the working method for abstract analyzing the abstract object of the computer system, abstract operating with the abstract object, abstract storing the abstract object and abstract finding the abstract object again. For abstract analyzing, the cyborg-interpreter uses the phrase which contains the associative object. This phrase is parsed on the single words. Every parsed word is defined as the part of speech and/or as the part of a sentence. Then every word of the phrase will be analyzed abstractly, with regard to the class classification, the polymorphism, the units of measurement, the intonation.

Then every word of the phrase will be stored uniquely for the long term, classified according to an action in one natural language, with an analytic entity, with having consideration for the word order of the phrase, relative to time of summarizing the incoming signals of the sensors groups by the corresponding associative object. In this way, a phrase stored word by word represents an abstract object of the computer system.

The computer system operates with this abstract object at work.

For example, thus, a new class is specified in the class classification according to inheritance or a new unknown object is polymorphically arranged to an existing class.

The abstract object can be found by the computer system over and over again. The associative object will be found corresponding to the abstract object. The subjective object will be found corresponding to the associative object.

The subjective object can be returned.

FIG. 5 illustrates the working method for abstract transmitting back the abstract object of the computer system. The subjective object is split into the single signals of the sensors groups on its return, i.e. the output mode, output value, and output unit of measurement will be defined for every output interface of the sensors groups. For example, the output modes: React_Object1, React_Object2, React_Object3, React_Object4, React_Object5, the output values: S1, S2, S3, S4 and S5. In addition, the output units of measurement can be also defined.

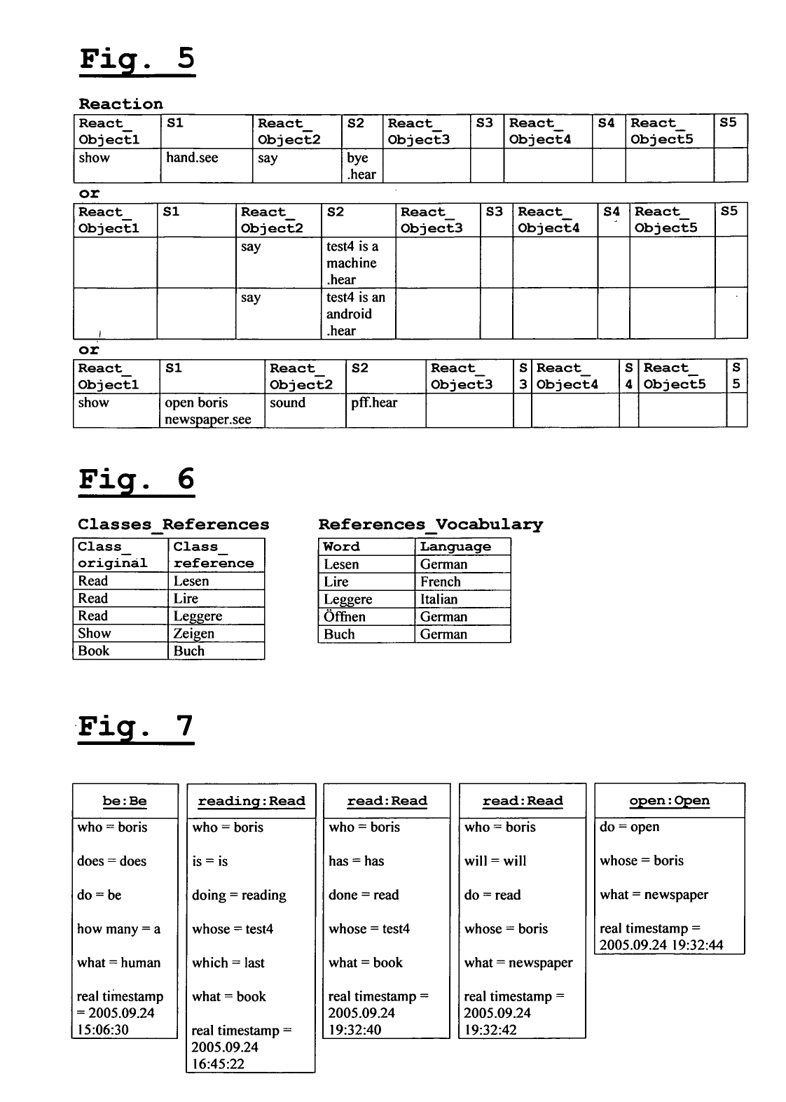

FIG. 6 illustrates the working method used by the computer system for working in another natural language or in several natural languages. The computer system uses one natural language for the working method. For the working method in the first, original, natural language, the computer system can use references in another natural language to words in the first, original, natural language. Thus, it is illustrated that the computer system uses only one natural language for its working method.

But for working method in another natural language, the computer system needs the abstract objects in the other natural language. Therefore, the computer system will use the references (i.e. the abstract objects in another natural language) in another natural language to the abstract objects in the first, original, natural language during the working method in the other natural language. The same logic will be used for several natural languages.

FIG. 7 shows some examples of the objects generated into the abstract objects in one natural language. Each abstract object is defined relative to time (for example is provided with timestamp). Each abstract object represents an action in the same natural language. The computer system operates with the objects during its working method. The classes from the objects or the objects themselves are preprogrammed in no computer language.

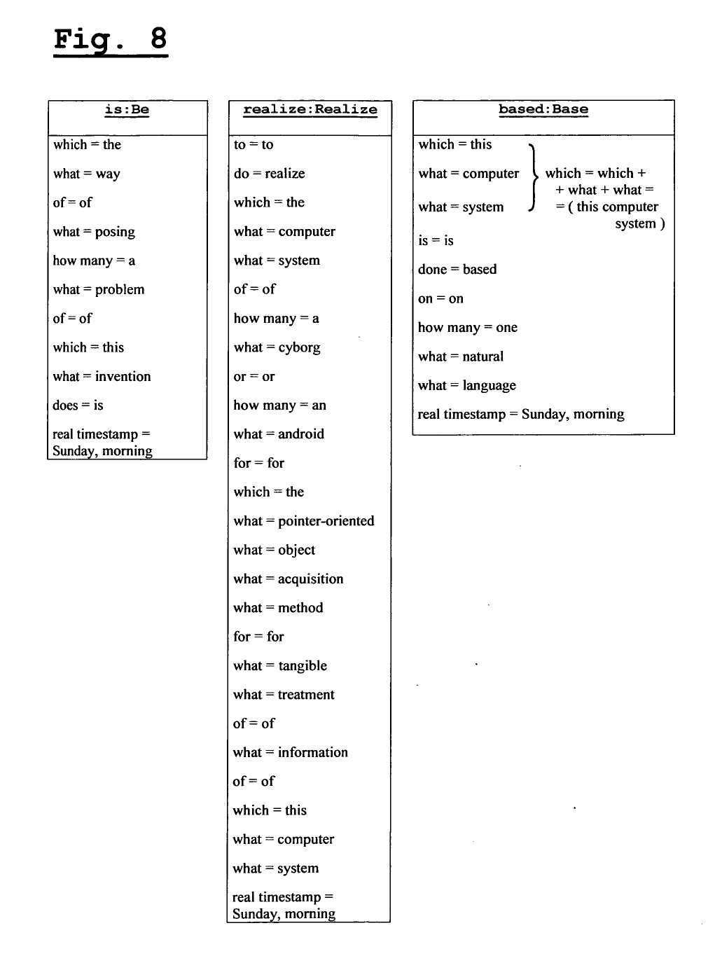

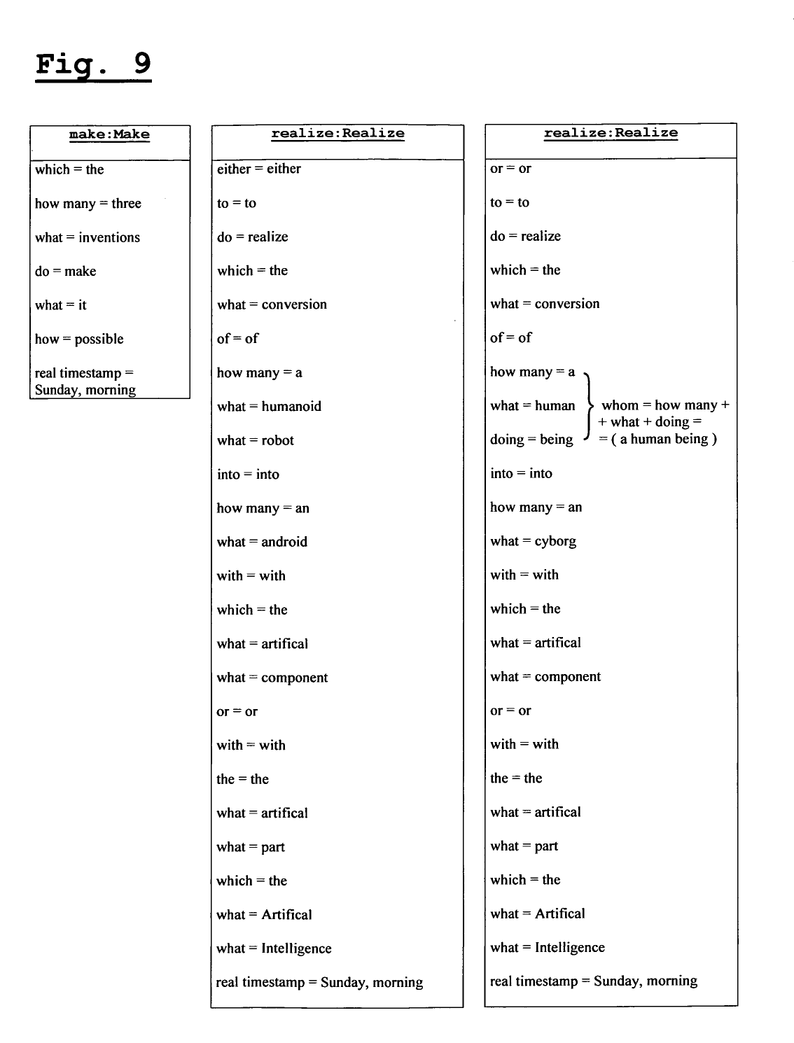

FIG. 8 shows some more examples of the objects generated into the abstract objects in one natural language. In this patent application, a machine is realized. The machine substantiates the subjective object of the computer system of Artificial Intelligence of a cyborg or an android from the incoming signals of the outside world which have been received with the sensors groups, or rather creates a received signal-reactions substance. Further, the machine substantiates the associative object of the computer system of Artificial Intelligence of a cyborg or an android from this received signal-reactions substance, or rather creates a corresponding association substance. Furthermore, the machine substantiates the abstract object of the computer system of Artificial Intelligence of a cyborg or an android from this corresponding association substance, or rather creates a corresponding thought substance. The machine is able to think in the human way or rather to manipulate with its own thoughts. After its own thinking, or rather after manipulating with its own thoughts, the machine will come to its own decision for its future actions.

Following information is written in the section OBJECTIVES OF THE INVENTION of the specification (specification, section OBJECTIVES OF THE INVENTION, paragraph 0195). If you gave a robot a command to read the information, the information would also be read to you:

“The way of posing a problem of this invention is to realize the computer system of Artificial Intelligence of a cyborg or an android for the pointer-oriented object acquisition method for tangible treatment of information of this computer system which is based on one natural language.”

If you asked a cyborg or an android to read the information, the following would occur (also like a human being).

The information contains a thought which has been summarized from three thoughts, or rather from three abstract objects. One object “is” (but rather the object “be”, because “The way of posing a problem of this invention does be . . . ” would be understood) of the class “Be”, one object “realize” of the class “Realize”, and one object “based” of the class “Base”. As a matter of course, the information will be processed as the received signal-reactions of the computer system of Artificial Intelligence of a cyborg or an android, then as the corresponding association of the computer system of Artificial Intelligence of a cyborg or an android, and then as the corresponding thought of the computer system of Artificial Intelligence of a cyborg or an android.

First of all, all reactions from the incoming signals of all n senses, or rather of all n sense organs sensor groups (or rather at least five sense organs sensor groups), are summarized with all the sensor groups to an object. This means for example,

the specification, section OBJECTIVES OF THE INVENTION, paragraph 0195,—looking like;

the specification, section OBJECTIVES OF THE INVENTION, paragraph 0195,—sounding;

the specification, section OBJECTIVES OF THE INVENTION, paragraph 0195,—scenting;

the specification, section OBJECTIVES OF THE INVENTION, paragraph 0195,—tasting;

the specification, section OBJECTIVES OF THE INVENTION, paragraph 0195,—touching.

As a matter of course, some reactions have been initialized with null. However, the reactions will be contained in the object. The signal-reactions object will not be treated relative to time.

Then, a corresponding association object of the computer system of Artificial Intelligence of a cyborg or an android to the signal-reactions object will be built. Please take into consideration that the association will be treated relative to time.

After that, a corresponding thought object of the computer system of Artificial Intelligence of a cyborg or an android to the association will be created. The corresponding thought object will be shown in the FIG. 8.

Thus, the signal-reactions object from the section OBJECTIVES OF THE INVENTION of the specification will be administrated in one natural language, in this case in English. This means, one can further work with the signal-reactions object with aid of the corresponding thought, think about the corresponding thought, reply to the corresponding thought and so on.

FIG. 9 shows some more examples of the objects generated into the abstract objects in one natural language.

Following information is located in the section BRIEF SUMMARY OF THE INVENTION of the specification (specification, section BRIEF SUMMARY OF THE INVENTION, paragraph 0225). If you gave a robot a command to read the information, the information would also be read to you:

“The three inventions make it possible either the conversion of a humanoid robot into an android or the conversion of a human being into a cyborg with the artificial component, or with the artificial part,—the Artificial Intelligence.”

If you asked a cyborg or an android to read the information, the following would take place (also like a human being).

The information contains a thought which has been summarized from three thoughts, or rather from three abstract objects. One object “make” of the class “Make” and two objects “realize” of the class “Realize”. As a matter of course, the information will be processed as the received signal-reactions of the computer system of Artificial Intelligence of a cyborg or an android, then as the corresponding association of the computer system of Artificial Intelligence of a cyborg or an android, and then as the corresponding thought of the computer system of Artificial Intelligence of a cyborg or an android.

This means, firstly, all reactions from the incoming signals of all n senses, or rather of all n sense organs sensor groups (or rather at least five sense organs sensor groups), are summarized with all the sensor groups to an object. For example,

the specification, section BRIEF SUMMARY OF THE INVENTION, paragraph 0225,—looking like;

the specification, section BRIEF SUMMARY OF THE INVENTION, paragraph 0225,—sounding;

the specification, section BRIEF SUMMARY OF THE INVENTION, paragraph 0225,—scenting;

the specification, section BRIEF SUMMARY OF THE INVENTION, paragraph 0225,—tasting;

the specification, section BRIEF SUMMARY OF THE INVENTION, paragraph 0225,—touching.

As a matter of course, some reactions have been initialized with null. However, the reactions will be contained in the object. The signal-reactions object will not be treated relative to time.

Then, a corresponding association object of the computer system of Artificial Intelligence of a cyborg or an android to the signal-reactions object will be built. The association will be treated relative to time.

After that, a corresponding thought object of the computer system of Artificial Intelligence of a cyborg or an android to the association will be created. This corresponding thought object will be shown in the FIG. 9.

The computer system of Artificial Intelligence of a cyborg or an android which is described in this patent application has already been implemented and can be running as a system simulation.

The computer system, or rather the machine, gives a cyborg or an android, a mentally ill or neurological ill patient or also a human being which was born mentally handicapped the possibility to live in or to be involved in this world on our (your or my) mental level, or rather to possess of the equivalent thoughts as all of us, and to live in or to be involved in this world with the equivalent thoughts.

The computer system, or rather the machine, increase the possibility to recognize, to catch, and to isolate a criminal or a terrorist as the prevention of criminality or terrorism. Thus, the criminal or the terrorist will have no chance to commit anything against or to operate against.

The computer system of Artificial Intelligence of a cyborg or an android like the human brain whose working method, or rather the functionality, is presented with the mind does not use in its working method a programming language but rather one natural language.

There follow 6 sheets of drawings.

1. A computer system of Artificial Intelligence of a cyborg or an android, comprising:
a plurality of pointers created in a computer random access memory of the computer system of Artificial Intelligence of the cyborg or the android as subjective objects, wherein a received signal-reaction is substantiated with each subjective object;
a plurality of pointers created in a computer random access memory of the computer system of Artificial Intelligence of the cyborg or the android as associative objects, wherein an association is substantiated with each associative object;
a plurality of pointers created in a computer random access memory of the computer system of Artificial Intelligence of the cyborg or the android as abstract objects, wherein a thought is substantiated with each abstract object;
at least five senses equipped with sense organs, wherein the senses are a sense of sight, a sense of hearing, a sense of smell, a sense of taste, a sense of touch;
a sensors group of each sense organ; and
a sensors network, wherein the sensors network of the computer system summarizes all reactions of all sense organs of all senses.

2. A computer system of Artificial Intelligence of a cyborg or en android, comprising:
a plurality of pointers created in a computer random access memory of the computer system of Artificial Intalliganca of tho cyborg or the android as subjective objects, wherein a received signal-reaction is substantiated with each subjective object;
a plurality of pointers created in a computer random access memory of the computer system of Artificial Intelligence of the cyborg or the android as associative objects, wherein an association is substantiated with each associative object; at least one corresponding association corresponding to at least one received signal-reaction;
a plurality of pointers created in a computer random access memory of the computer system of Artificial Intelligence of the cyborg or the android as abstract objects, wherein a thought is substantiated with each abstract object; at least one corresponding thought corresponding to at least one corresponding association;
at least five senses equipped with sense organs, wherein the senses are a sense of sight, a sense of hearing, a sense of smell, a sense of taste, a sense of touch; and
a plurality of classes having the pointers as objects, wherein each received signal-reaction, each corresponding association, and each corresponding thought are the corresponding objects of the same class.

3. The computer system according to claim 2,
wherein the computer system defines the class of each received signal-reaction, each corresponding association, and each corresponding thought as an action in one natural language.

4. The computer system according to claim 3,
wherein the computer system uses a word in another natural language as a reference to a word In the first natural language for a working method in the first natural language.

5. The computer system according to claim 1,
wherein the subjective object is unique with respect to a complete signal-reactions-comblnatlon of all of the sense organs from the at least five senses.

6. The computer system according to claim 5,
wherein the computer system does not treat the Subjective object relative to time.

7. The computer system according to claim 5,
wherein the computer system provides for output the subjective object split in accordance with the sensors groups.

8. Tne computer system according to claim 1,
wherein the associative object knows only the corresponding subjective object but does not know the surroundings.

9. The computer system according to claim 8,
wherein the associative object comprises a complete signal-reactions-combination of all of the sense organs from the at least five senses,
wherein the associative object is unique with respect to the association.

10. The computer system according to claim 8,
wherein the computer system treats the associative object relative to time but not uniquely.

11. The computer system according to claim 1,
wherein the abstract object knows only the corresponding associative object but does not know the corresponding subjective object and neither, certainly, the surroundings.

12. The computer system according to claim 11,
wherein the abstract object is unique with respect to a complete words-combination of a vocabulary of both associative words and abstract words to the associative words, or rather to the corresponding association.

13. The computer system according to claim 11,
wherein the abstract object can be unique with respect to a complete words-combination of a vocabulary only of abstract words, which are represented In the corresponding association.

14. The computer system according to claim 11,
wherein the computer system treats the abstract object relative to time but not uniquely.

15. The computer system according to claim 11,
wherein a reference in another natural language to the abstract object is used for a working method in the other natural language.

16. The computer system according to claim 2,
further comprising a database including database tables, each database table having at least one primary key:
wherein each primary key is implemented only using column combination from the database table.

17. The computer system according to claim 16,
wherein the database does not include specific computer language column types for the primary keys,
wherein each primary key is implemented without at least one specific computer language column type for the primary keys.

18. A working method of a computer system of Artificial Intelligence of a cyborg or an android, said working method comprising the steps of:
summarizing, subjectively relating to the computer system of Artificial Intelligence of the cyborg or the android, all reactions of all sensors groups of all sense organs that represent all senses to a received signal-reaction of the computer system of Artificial intelligence of the cyborg or the android,
wherein each of the senses is equipped with at least one sense organ,
wherein the senses are at least five senses,
wherein the at least five senses are a sense of eight, a sense of hearing, a sense of smell, sense of taste, a sense of touch;
transforming the received signal-reaction into a corresponding association of the computer system of Artificial Intelligence of the cyborg or the android, in one natural language,
wherein the computer system analyzes the received signal-reaction In the one natural language with respect to the other associations of the computer system of Artificial intelligence of the cyborg or the android,
wherein the computer system completes the received signal-reaction in the one natural language relative to time, wherein the computer system works in the one natural language, and the computer system completes the received signal-reaction in the one natural language associatively to the computer system of Artificial Intelligence of the cyborg or the android, wherein the computer system works in the one natural language,
wherein at least one corresponding association corresponds with at least one received signal-reaction, wherein the corresponding association corresponds with the received signal-reaction in the one natural language:
storing the corresponding association after the step of transforming the received signal-reaction into the corresponding association;
analyzing the corresponding association, abstractly relating to the computer system of Artificial Intelligence of the cyborg or the android, in the one natural language,
word by word,
with a part of speech,
as a part of a sentence,
with regard to a class classification, a polymorphism, units of measurement,
with regard to an intonation;
transforming the corresponding association into a corresponding thought of the computer system of Artificial Intelligence of the cyborg or the android, in the one natural language,
word by word,
with at least one analytic entity,
with having consideration for a word order of a phrase,
relative to time,
wherein the corresponding thought is classified according to an action in the one natural language,
wherein at least one corresponding thought corresponds with at least one corresponding association,
wherein the corresponding thought corresponds with the corresponding association in the one natural language;
storing the corresponding thought, classified according to the action in the one natural language,
word by word,
with the at least one analytic entity,
with having consideration for the word order of the phrase,
relative to time;
operating the corresponding thought;
finding the corresponding association again;
extracting the received signal-reaction from the corresponding association; and
returning the received signal-reaction.

19. The computer system according to claim 3,
wherein each received signal-reaction, each corresponding association, and each corresponding thought are connected together only by the one natural language.
